(19) United States
(12) Patent Application Publication
(10) Pub. No.: US 2026/0290002 A1
(43) Pub. Date: Sep. 24, 2026

(54) PICTURE DETECTION METHOD, DEVICE, EQUIPMENT AND MEDIUM

(71) Applicant: Welab Information Technology (shenzhen) Limited., Shenzhen (CN)

(72) Inventors: Cheng Shao, Shenzhen (CN); Huanming Wu, Shenzhen (CN)

(21) Appl. No.: 19/235,669

(22) Filed: Jun. 12, 2025

(30) Foreign Application Priority Data
Mar. 20, 2025 (CN) 202510333736.9

(51) Int. Cl. G06V 10/98; G06V 10/24; G06V 10/26; G06V 10/28; G06V 10/44; G06V 10/50; G06V 10/60; G06V 10/82; G06V 30/12; G06V 30/146; G06V 30/148; G06V 30/162; G06V 30/18; G06V 30/41

(52) U.S. Cl. CPC G06V 10/993; G06V 10/242; G06V 10/26; G06V 10/28; G06V 10/443; G06V 10/507; G06V 10/60; G06V 10/82; G06V 30/133; G06V 30/1463; G06V 30/153; G06V 30/162; G06V 30/1801; G06V 30/18095; G06V 30/18124; G06V 30/41

(57) ABSTRACT

The present invention discloses a picture detection method, including: confirming a portrait direction on a certificate picture to obtain a correct state certificate picture; acquiring a highlight region of the correct state certificate picture and judging whether the highlight region is a light reflection region, and if yes, acquiring a non-light reflection region picture of the correct state certificate picture; identifying text region defect features and portrait region defect features in the non-light reflection region picture, identifying a complete text region according to the text region defect features, and identifying a complete portrait region according to the portrait region defect features; dividing the key information region of the correct state certificate picture according to the complete text region and the complete portrait region, and obtaining a key information picture, and sending the key information picture to the server so as to improve the accuracy and efficiency of picture detection.

### CROSS REFERENCE TO RELATED APPLICATIONS

The present application claims the benefit of Chinese Patent Application No. 202510333736.9 filed on Mar. 20, 2025, the contents of which are incorporated herein by reference in their entirety.

### TECHNICAL FIELD

The present invention relates to the technical field of picture identification, and more particularly, to a picture detection method, device, equipment and medium.

### BACKGROUND

In the field of image processing and computer vision, the light reflection region in the certificate image often interferes with the identification of key information regions. For example, in a scene where a certificate picture is needed, the reflection of the surface of the certificate picture may result in a partial region of a key information region (such as a region of name, gender, date of birth, certificate number, etc.) in an image acquired by a camera being covered by the reflection, which may make it difficult for a computer to accurately identify the complete key information region.

At present, certificate image identification technology mainly relies on text detection and text identification technology, which converts certificate image into text content and extracts key information from it and saves it as structured output in the form of key-value pairs. However, the existing method will prompt the user to upload the picture again after identifying the light reflection in the key information region in the certificate picture, which cannot be processed in the next step, which reduces the efficiency of the certificate picture detection and identification.

### SUMMARY

The present invention provides an artificial intelligence picture detection method, device, equipment and medium, so as to solve the problem of low efficiency of existing picture detection methods.

In a first aspect, there is provided a picture detection method, including:
acquiring a certificate picture uploaded by a user, and confirming a portrait direction on the certificate picture so as to obtain a correct state certificate picture;
acquiring a highlight region of the correct state certificate picture;
judging whether the highlight region is a light reflection region;
if the highlight region is not a light reflection region, sending the correct state certificate picture to a server;
if the highlight region is a light reflection region, acquiring a non-light reflection region picture of the correct state certificate picture, and identifying text region defect features and portrait region defect features in the non-light reflection region picture;
using a pre-trained text region boundary identification model to identify a complete text region in the correct state certificate picture according to the text region defect features, and using a pre-trained portrait region boundary identification model to identify a complete portrait region in the correct state certificate picture according to the portrait region defect features;
dividing a key information region of the correct state certificate picture according to the complete text region and the complete portrait region so as to obtain a key information picture, and sending the key information picture to a server.

In a second aspect, there is provided a picture detection device, including:
a picture direction confirmation module configured for acquiring a certificate picture uploaded by a user, and confirming a portrait direction on the certificate picture so as to obtain a correct state certificate picture;
a highlight region identification module configured for acquiring a highlight region of the correct state certificate picture;
a light reflection judgement module configured for judging whether the highlight region is a light reflection region, if the highlight region is not a light reflection region, sending the correct state certificate picture to a server, and if the highlight region is a light reflection region, acquiring a non-light reflection region picture of the correct state certificate picture, and identifying text region defect features and portrait region defect features in the non-light reflection region picture;
a complete region identification module configured for using a pre-trained text region boundary identification model to identify a complete text region in the correct state certificate picture according to the text region defect features, and using a pre-trained portrait region boundary identification model to identify a complete portrait region in the correct state certificate picture according to the portrait region defect features;
a key information picture identification module configured for dividing a key information region of the correct state certificate picture according to the complete text region and the complete portrait region so as to obtain a key information picture, and sending the key information picture to a server.

In a third aspect, there is provided an electronic equipment, including a memory, a processor and a computer program stored in the memory and executable on the processor, the computer program which, when executed by the processor implements the steps of the above-described picture detection method.

In a fourth aspect, there is provided a non-volatile computer-readable storage medium, the computer-readable storage medium storing a computer program which, when executed by the processor implements the steps of the above-described picture detection method.

The solution realized by the above-mentioned picture detection method, device, electronic equipment and storage medium includes the steps of: acquiring a certificate picture uploaded by a user, and confirming a portrait direction on the certificate picture so as to obtain a correct state certificate picture; acquiring a highlight region of the correct state certificate picture; judging whether the highlight region is a light reflection region; if the highlight region is not a light reflection region, sending the correct state certificate picture to a server; and if the highlight region is a light reflection region, acquiring a non-light reflection region picture of the correct state certificate picture, and identifying text region defect features and portrait region defect features in the non-light reflection region picture; using a pre-trained text region boundary identification model to identify a complete text region in the correct state certificate picture according to the text region defect features, and using a pre-trained portrait region boundary identification model to identify a complete portrait region in the correct state certificate picture according to the portrait region defect features; and dividing a key information region of the correct state certificate picture according to the complete text region and the complete portrait region so as to obtain a key information picture, and sending the key information picture to a server. The security of financial transactions is improved.

### BRIEF DESCRIPTION OF THE ACCOMPANYING DRAWINGS

In order to explain the technical solutions of the embodiments of the present invention more clearly, a brief description will be given below with reference to the accompanying drawings which are required to be used in the description of the embodiments of the present invention. It is obvious that the drawings in the description below are only some embodiments of the present invention, and it would have been obvious for a person of ordinary skill in the art to obtain other drawings according to these drawings without involving any inventive effort.

FIG. 1 is a schematic diagram showing an application environment of a picture detection method of an embodiment of the present invention;

FIG. 2 is a schematic flow diagram showing a picture detection method of an embodiment of the present invention;

FIG. 3 is a schematic structure diagram showing a picture detection device of an embodiment of the present invention;

FIG. 4 is a schematic structure diagram showing an electronic equipment of an embodiment of the present invention; and

FIG. 5 is an another schematic structure diagram showing an electronic equipment of an embodiment of the present invention.

### DETAILED DESCRIPTION OF ILLUSTRATED EMBODIMENTS

The technical solutions in the embodiments of the present invention will be clearly and completely described below with reference to the drawings in the embodiments of the present invention, and it is obvious that the described embodiments are a part of the embodiments of the present invention, and not all of the embodiments. Based on the embodiments of the present invention, all other embodiments obtained by a person of ordinary skill in the art without inventive effort fall within the scope of the present invention.

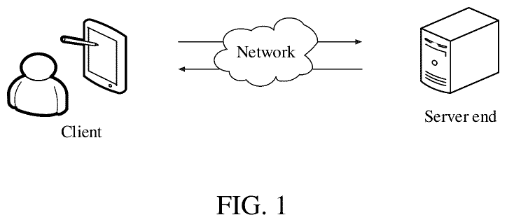

A picture detection method provided by an embodiment of the present invention can be applied in an application environment as shown in FIG. 1, wherein a client communicates with a server end through a network. A server end can acquire a certificate picture uploaded by a user via a client, confirm a portrait direction on the certificate picture so as to obtain a correct state certificate picture; acquiring a highlight region of the correct state certificate picture; judge whether the highlight region is a light reflection region; if the highlight region is not a light reflection region, send the correct state certificate picture to a server; and if the highlight region is a light reflection region, acquire a non-light reflection region picture of the correct state certificate picture, and identify text region defect features and portrait region defect features in the non-light reflection region picture; use a pre-trained text region boundary identification model to identify a complete text region in the correct state certificate picture according to the text region defect features, and use a pre-trained portrait region boundary identification model to identify a complete portrait region in the correct state certificate picture according to the portrait region defect features; and divide a key information region of the correct state certificate picture according to the complete text region and the complete portrait region so as to obtain a key information picture, and send the key information picture to a server. The efficiency and accuracy of picture detection are improved. Among other things, the client may be, but is not limited to, a variety of personal computers, notebook computers, smart phones, tablet computers, and portable wearable equipments. The server end may be an independent server or a server cluster composed of a plurality of servers. The present invention will now be described in more detail by way of specific embodiments.

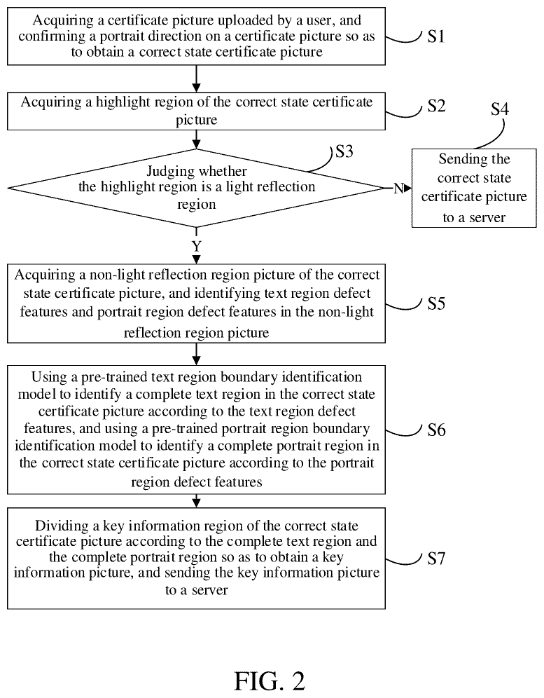

With reference to FIG. 2, FIG. 2 is a schematic flow diagram showing a picture detection method provided by an embodiment of the present invention, including the following steps.

S1. Acquiring a certificate picture uploaded by a user, and confirming a portrait direction on the certificate picture so as to obtain a correct state certificate picture;

In an embodiment of the present invention, confirming a portrait direction on the certificate picture so as to obtain a correct state certificate picture includes:
acquiring a portrait direction of the certificate picture;
judging whether the portrait direction is a pre-set correct direction;
if the portrait direction is a pre-set correct direction, confirming that the certificate picture is a correct state certificate picture;
if the portrait direction is not a pre-set correct direction, rotating the certificate picture so that the portrait direction of the certificate picture is the correct direction, and obtaining a correct state certificate picture.

In detail, the acquiring the portrait direction of the certificate picture is to use an edge identification algorithm to identify the portrait contour of the certificate picture, match the identified portrait contour with a pre-set portrait contour template with different directions, and confirm the portrait direction of the certificate picture according to the direction of the matched portrait contour template.

In detail, the judging whether the portrait direction is a pre-set correct direction is by representing the portrait direction and the correct direction by numbers or codes, and judging whether the portrait direction is a pre-set correct direction by judging whether the numbers or codes corresponding to the portrait direction and the correct direction are the same.

In detail, the above-mentioned rotation of the certificate picture makes the portrait direction of the certificate picture be the correct direction so as to obtain a correct state certificate picture, wherein after the certificate picture after each rotation, the portrait direction of the certificate picture is acquired once and compared with the correct direction until the portrait direction of the certificate picture after the rotation is the correct direction so as to confirm that the certificate picture is in the correct state.

In an embodiment of the present invention, by acquiring a certificate picture uploaded by a user, and confirming a portrait direction on the certificate picture so as to obtain a correct state certificate picture, it can be ensured that the certificate picture is in a correct state, so as to improve the efficiency of subsequent processing.

S2. Acquiring a highlight region of the correct state certificate picture.

In an embodiment of the present invention, acquiring a highlight region of the correct state certificate picture includes:
acquiring a histogram of the correct state certificate picture;
identifying, based on the histogram, a pixel point of which a pixel value is greater than a pre-set highlight threshold value in the correct state certificate picture, and obtaining a highlight region.

In detail, the histogram is a graphical representation showing the distribution of the values of each pixel in the image. For grey-scale images, the histogram shows the number of pixels per grey-scale from 0 (black) to 255 (white); for color images, there are typically three histograms, corresponding to the pixel values of the red, green, and blue channels, respectively.

In detail, the highlight threshold value is a threshold value set for distinguishing whether a pixel point is highlighted or not, and the pixel value of the highlighted pixel point is generally close to 255, and the highlight threshold value may be set according to the requirements.

In an embodiment of the present invention, acquiring a highlight region of the correct state certificate picture improves the efficiency of subsequently judging whether the highlight region is a light reflection region.

S3. Judging whether the highlight region is a light reflection region.

In an embodiment of the present invention, judging whether the highlight region is a light reflection region is to judge whether it is a light reflection region by calculating the magnitude relationship between the sharpness of pixels in the highlight region and a pre-set sharpness threshold value.

If the highlight region is not a light reflection region, S4 is executed, and the correct state certificate picture is sent to the server.

In an embodiment of the present invention, when it is judged that the highlight region is not a light reflection region, it is indicated that a key information region in the certificate picture is not blocked by light reflection, and the information display is complete, so that the information can be sent to a server for identification in the next step.

If the highlight region is a light reflection region, S5 is executed to acquire a non-light reflection region picture of the correct state certificate picture, and to identify text region defect features and portrait region defect features in the non-light reflection region picture.

In an embodiment of the present invention, when it is judged that the highlight region is a light reflection region, it is indicated that the key information region of the correct state certificate picture has been affected by the reflection, and there may be a problem of inaccurate identification, and therefore it is necessary to acquire a non-light reflection region of the correct state certificate picture for further processing to re-identify the key information region.

In an embodiment of the present invention, the acquiring a non-light reflection region picture of the correct state certificate picture is performing picture division according to the highlight region, and acquiring a part outside the highlight region in the certificate picture so as to obtain the non-light reflection region picture.

In an embodiment of the present invention, identifying the text region defect features and the portrait region defect features in the non-light reflection region picture includes:
performing binarized processing on the non-light reflection region picture to obtain a binarized picture;
using an edge detection algorithm to identify discontinuous boundary features and defect regular edge features in the binarized picture;
using a text detection algorithm to perform text detection on the discontinuous boundary features and the defect regular edge features so as to obtain the text region defect features; and
performing portrait contour matching on the discontinuous boundary features and the defect regular edge features to obtain the portrait region defect features.

In an embodiment of the present invention, the binarized image is a type of image after digital image processing. It is a grey-scale image (each pixel point of the image has a grey-scale value, usually in the range of 0-255). By setting a threshold value, the grey-scale value of each pixel point is converted into an image having only two values (usually 0 and 1, or 0 and 255) according to the magnitude relationship between the grey-scale value of each pixel point and the threshold value, so that the binarized image is an image having only two colors (usually black and white).

In an embodiment of the present invention, performing binarized processing on the non-light reflection region picture to obtain a binarized picture includes:
performing grey-scale processing on the non-light reflection region picture to obtain a grey-scale picture;
acquiring a grey-scale value of each pixel point of the grey-scale picture to obtain grey-scale value data;
acquiring a median of the grey-scale value data to obtain a grey-scale threshold value;
according to the grey-scale value data, setting the grey-scale value of a pixel point in the grey scale picture which is greater than the grey-scale threshold value as 1, and setting the grey-scale value of a pixel point which is less than or equal to the grey-scale threshold value as 0, so as to obtain a binarized image.

In detail, the grey-scale processing is a basic step in image processing, and it converts a color image into a grey-scale image, i.e. each pixel has only one intensity value, representing its brightness, so as to simplify the image data, reduce the subsequent computational complexity, and at the same time preserve the image information.

In an embodiment of the present invention, the text detection algorithm is an algorithm for identifying a text region from a picture, and a conventional text detection algorithm includes the steps of reading a picture, converting same into a grey scale image, binarizing, expanding and eroding operations to highlight a contour, searching for a contour and removing a frame which does not comply with the characteristics of the text, and finally returning a frame result of the text detection.

In an embodiment of the present invention, performing portrait contour matching on the discontinuous boundary features and the defect regular edge features is to calculate a matching degree by calculating a vector distance between the discontinuous boundary features and the defect regular edge features and a pre-set portrait contour target, and when the matching degree is greater than a certain threshold value, the matching is successful.

In an embodiment of the present invention, by acquiring a non-light reflection region picture of the correct state certificate picture, and identifying text region defect features and portrait region defect features in the non-light reflection region picture, the accuracy of identifying the text region defect features and the portrait region defect features is improved.

S6. Using a pre-trained text region boundary identification model to identify a complete text region in the correct state certificate picture according to the text region defect features, and using a pre-trained portrait region boundary identification model to identify a complete portrait region in the correct state certificate picture according to the portrait region defect features.

In an embodiment of the present invention, the portrait region boundary identification model is a neural network model, and an attention mechanism is introduced to improve the identification accuracy of the model.

In an embodiment of the present invention, the using a pre-trained text region boundary identification model to identify a complete text region in the correct state certificate picture according to the text region defect features includes:
using a neural network model to perform average pooling processing and maximum pooling processing on the text region defect features so as to obtain an average pooling feature and a maximum pooling feature;
splicing the average pooling feature and the maximum pooling feature on a channel dimension to obtain a splicing feature;
performing convolution processing and activation processing on the splicing feature to obtain a spatial attention map;
multiplying the spatial attention map and the text region defect features to obtain an attention weight; and
using a neural network model to output a complete text region of the certificate picture according to the attention weight and the text region defect features.

In an embodiment of the present invention, the attention mechanism is a form of information processing that mimics the human visual system, which enables the model to focus on certain important parts of the data when processing the data (particularly serial data or data with a spatial structure, such as text, images, etc.), rather than treating all input information equally. For example, in dealing with the task of identifying a complete boundary from a defect feature, the model may focus more on the circular arc portion and its surrounding pixels in the defect feature by adding an attention mechanism to improve the accuracy of the identification of the complete boundary.

In an embodiment of the present invention, performing convolution processing and activation processing on the splicing feature to obtain a spatial attention map is to use a convolution kernel of size 1*1 to perform convolution processing to obtain a convolution result of size 1*1*N (N being the number of output channels), then expanding the convolution result in a spatial dimension to obtain a tensor of size N*H*W (H*W being the size of the splicing feature), and using a sigmoid activation function to map each element in the tensor to an interval of (0, 1) to obtain the spatial attention map.

In an embodiment of the present invention, the performing convolution processing and activation processing on the splicing feature to obtain a spatial attention map includes: using a convolution kernel with a size of 1*1 being greater than the splicing feature to perform convolution so as to obtain a convolution result with a size of 1*1*N, wherein N is the number of output channels;
expanding the convolution result in a spatial dimension to obtain a feature tensor of size N*H*W, wherein H * W is the size of the splicing feature;
mapping each element in the feature tensor between 0 and 1 using a pre-set activation function to obtain a spatial attention map.

In an embodiment of the present invention, the step principle of using a pre-trained portrait region boundary identification model to identify a complete portrait region of the correct state certificate picture according to the portrait region defect features is the same as the step principle of using a pre-trained text region boundary identification model to identify a complete text region in the correct state certificate picture according to the text region defect features, and the description thereof will not be repeated here.

In an embodiment of the present invention, the accuracy of identifying a complete text region and a complete portrait region is improved by using a pre-trained text region boundary identification model to identify a complete text region in the correct state certificate picture according to the text region defect features, and using a pre-trained portrait region boundary identification model to identify a complete portrait region in the correct state certificate picture according to the portrait region defect features.

It can be seen that, in an embodiment of the present invention, aiming at the problem of light reflection in a certificate picture, by dividing a non-light reflection region in the certificate picture, identifying defect features of the non-light reflection region, and using a pre-trained neural network model to identify the complete information region according to the defect features.

S7. dividing a key information region of the correct state certificate picture according to the complete text region and the complete portrait region so as to obtain a key information picture, and sending the key information picture to a server.

In the embodiments of the present invention, the dividing a key information region of the correct state certificate picture according to the complete text region and the complete portrait region to obtain a key information picture refers to dividing a rated region where the complete text region and the complete portrait region are located in the correct state certificate picture to obtain the key information picture.

It should be understood that the size of the sequence numbers of the steps in the above-described embodiments does not imply the order of execution, and that the order of execution of the processes should be determined in terms of their functionality and inherent logic, and should not constitute any limitation on the implementation of the embodiments of the present invention.

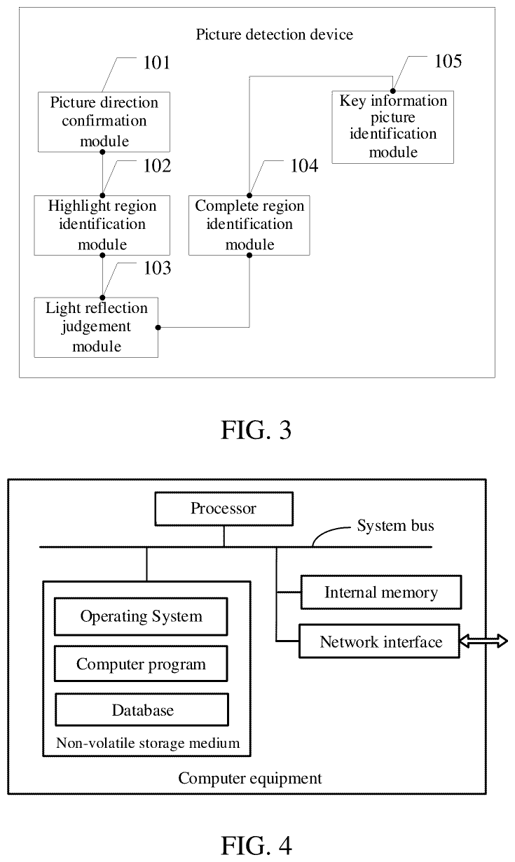

In one embodiment, there is provided a picture detection device, which corresponds to the picture detection method in the above-described embodiment on a one-to-one basis. As shown in FIG. 3, the picture detection device includes a picture direction confirmation module 101, a highlight region identification module 102, a light reflection judgement module 103, a complete region identification module 104 and a key information picture identification module 105. Each functional module is described in detail as follows:
a picture direction confirmation module 101 is configured for acquiring a certificate picture uploaded by a user, and confirming a portrait direction on the certificate picture so as to obtain a correct state certificate picture;
a highlight region identification module 102 is configured for acquiring a highlight region of the correct state certificate picture;
a light reflection judgement module 103 is configured for judging whether the highlight region is a light reflection region, if the highlight region is not a light reflection region, sending the correct state certificate picture to a server, and if the highlight region is a light reflection region, acquiring a non-light reflection region picture of the correct state certificate picture, and identifying text region defect features and portrait region defect features in the non-light reflection region picture;
a complete region identification module 104 is configured for using a pre-trained text region boundary identification model to identify a complete text region in the correct state certificate picture according to the text region defect features, and using a pre-trained portrait region boundary identification model to identify a complete portrait region in the correct state certificate picture according to the portrait region defect features;
a key information picture identification module 105 is configured for dividing a key information region of the correct state certificate picture according to the complete text region and the complete portrait region so as to obtain a key information picture, and sending the key information picture to a server.

In an embodiment, the picture direction confirmation module 101 is specifically configured for:
acquiring a portrait direction of the certificate picture;
judging whether the portrait direction is a pre-set correct direction;
if the portrait direction is a pre-set correct direction, confirming that the certificate picture is a correct state certificate picture;
if the portrait direction is not a pre-set correct direction, rotating the certificate picture so that the portrait direction of the certificate picture is the correct direction, and obtaining a correct state certificate picture.

In an embodiment, the highlight region identification module 102 is specifically configured for:
acquiring a histogram of the correct state certificate picture;
identifying, based on the histogram, a pixel point of which a pixel value is greater than a pre-set highlight threshold value in the correct state certificate picture, and obtaining a highlight region.

In one embodiment, the light reflection judgement module 103 is specifically configured for:
performing binarized processing on the non-light reflection region picture to obtain a binarized picture;
using an edge detection algorithm to identify discontinuous boundary features and defect regular edge features in the binarized picture;
using a text detection algorithm to perform text detection on the discontinuous boundary features and the defect regular edge features so as to obtain text region defect features; and performing portrait contour matching on the discontinuous boundary features and the defect regular edge features to obtain portrait region defect features.

In one embodiment, the light reflection judgement module 103 is specifically configured for:
performing grey-scale processing on the non-light reflection region picture to obtain a grey-scale picture; acquiring a grey-scale value of each pixel point of the grey-scale picture to obtain grey-scale value data;
acquiring a median of the grey-scale value data to obtain a grey-scale threshold value;
according to the grey-scale value data, setting the grey-scale value of a pixel point in the grey scale picture which is greater than the grey-scale threshold value as 1, and setting the grey-scale value of a pixel point which is less than or equal to the grey-scale threshold value as 0, so as to obtain a binarized image.

In an embodiment, the complete region identification module 104 is specifically configured for:
using a neural network model to perform average pooling processing and maximum pooling processing on the text region defect features so as to obtain an average pooling feature and a maximum pooling feature;
splicing the average pooling feature and the maximum pooling feature on a channel dimension to obtain a splicing feature;
performing convolution processing and activation processing on the splicing feature to obtain a spatial attention map;
multiplying the spatial attention map and the text region defect features to obtain an attention weight; and
using a neural network model to output a complete text region of the certificate picture according to the attention weight and the text region defect features.

In an embodiment, the complete region identification module 104 is specifically configured for:
using a convolution kernel with a size of 1*1 being greater than the splicing feature to perform convolution so as to obtain a convolution result with a size of 1*1*N, wherein N is the number of output channels;
expanding the convolution result in a spatial dimension to obtain a feature tensor of size N*H*W, wherein H*W is the size of the splicing feature;
mapping each element in the feature tensor between 0 and 1 using a pre-set activation function to obtain a spatial attention map.

The present invention provides a picture detection device for performing double state information verification on a bank card and an identity card of a user, and ensuring that the bank card information and the identity card data of the user can be accurately acquired; generating a front and a back picture of a certificate according to the identity card data; verifying the key input by the user by downloading a pre-set key and decrypting same, so as to ensure the reliability of the verification of the identity card of the user; and finally performing service access according to the bank card information and the front and back picture of the certificate, so as to improve the security of a financial transaction.

With regard to the specific definition of the picture detection device, reference can be made to the above definition of the picture detection method, which will not be described in detail herein. The respective modules in the above-described picture detection device may be implemented in whole or in part by software, hardware, or a combination thereof. The above modules can be embedded in hardware form or independent of the processor in the electronic equipment, or stored in software form in the memory of the electronic equipment, so that the processor can call and execute the corresponding operations of the above modules.

In one embodiment, there is provided an electronic equipment, which may be a server end, the internal structure diagram of which may be as shown in FIG. 4. The electronic equipment includes a processor, a memory, a network interface, and a database connected by a system bus. Among other things, the processor of the electronic equipment is configured for providing computing and control capabilities. The memory of the electronic equipment includes a non-volatile and/or volatile storage medium, an internal memory. The non-volatile storage medium stores an operating system, computer programs, and a database. The internal memory provides an environment for operating the operating system and computer programs in the non-volatile storage medium. The network interface of the electronic equipment is adapted to communicate with an external client via a network connection. The computer program, when executed by a processor, implements the functions or steps of the server end side of a picture detection method.

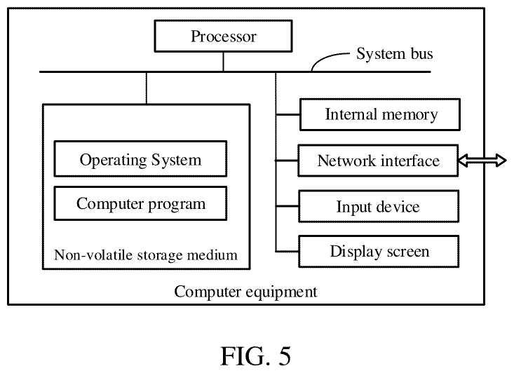

In one embodiment, there is provided an electronic equipment, which may be a client, the internal block diagram of which may be as shown in FIG. 5. The electronic equipment includes a processor, a memory, a network interface, a display screen, and an input device connected by a system bus. Among other things, the processor of the electronic equipment is configured for providing computing and control capabilities. The memory of the electronic equipment includes a non-volatile storage medium, and an internal memory. The non-volatile storage medium stores an operating system and computer programs. The internal memory provides an environment for operating the operating system and computer programs in the non-volatile storage medium. The network interface of the electronic equipment is adapted to communicate with an external server via a network connection. The computer program, when being executed by a processor, implements a function or step at the client side of a picture detection method

In one embodiment, there is provided an electronic equipment, including a memory, a processor and a computer program stored in the memory and executable on the processor, wherein when the computer program is executed by the processor, the following steps are implemented: acquiring a certificate picture uploaded by a user, and confirming a portrait direction on the certificate picture so as to obtain a correct state certificate picture;
acquiring a highlight region of the correct state certificate picture;
judging whether the highlight region is a light reflection region;
if the highlight region is not a light reflection region, sending the correct state certificate picture to a server;
if the highlight region is a light reflection region, acquiring a non-light reflection region picture of the correct state certificate picture, and identifying text region defect features and portrait region defect features in the non-light reflection region picture;
using a pre-trained text region boundary identification model to identify a complete text region in the correct state certificate picture according to the text region defect features, and using a pre-trained portrait region boundary identification model to identify a complete portrait region in the correct state certificate picture according to the portrait region defect features;
dividing a key information region of the correct state certificate picture according to the complete text region and the complete portrait region so as to obtain a key information picture, and sending the key information picture to a server.

In one embodiment, there is provided a computer-readable storage medium, on which a computer program is stored, which when executed by a processor implements the following steps:
acquiring a certificate picture uploaded by a user, and confirming a portrait direction on the certificate picture so as to obtain a correct state certificate picture;
acquiring a highlight region of the correct state certificate picture;
judging whether the highlight region is a light reflection region;
if the highlight region is not a light reflection region, sending the correct state certificate picture to a server;
if the highlight region is a light reflection region, acquiring a non-light reflection region picture of the correct state certificate picture, and identifying text region defect features and portrait region defect features in the non-light reflection region picture;
using a pre-trained text region boundary identification model to identify a complete text region in the correct state certificate picture according to the text region defect features, and using a pre-trained portrait region boundary identification model to identify a complete portrait region in the correct state certificate picture according to the portrait region defect features;
dividing a key information region of the correct state certificate picture according to the complete text region and the complete portrait region so as to obtain a key information picture, and sending the key information picture to a server.

It should be noted that the functions or steps described above with respect to the computer-readable storage medium or the electronic equipment can be implemented by referring to the relevant description of the server end side and the client side in the foregoing method embodiments, and in order to avoid repetition, the description thereof will not be repeated.

It will be appreciated by those of ordinary skill in the art that implementing all or part of the flow of the methods of the embodiments described above can be accomplished by instructing the associated hardware by a computer program which can be stored on a non-volatile computer-readable storage medium and which, when executed, can include the flow of the embodiments of the methods as described above. Among other things, any reference to memory, storage, databases, or other media used in the embodiments provided herein may include non-volatile and/or volatile memory. The non-volatile memory may include a read only memory (ROM), a programmable ROM (PROM), an electrically programmable ROM (EPROM), an electrically erasable programmable ROM (EEPROM) or a flash memory. Volatile memory can include random access memory (RAM) or external cache memory. By way of illustration and not limitation, RAM are available in many forms such as static RAM (SRAM), dynamic RAM (DRAM), synchronous DRAM (SDRAM), double data rate SDRAM (DDRSDRAM), enhanced SDRAM (ESDRAM), synchronization link (Synchlink), DRAM (SLDRAM), memory bus (Rambus) direct RAM (RDRAM), direct memory bus dynamic RAM (DRDRAM), and memory bus dynamic RAM (RDRAM), among others.

It will be clear to a person skilled in the art that, for the convenience and brevity of description, the above-mentioned division of various functional units and modules is merely exemplified, and in practical applications, the above-mentioned functional allocation may be completed by different functional units and modules according to needs, namely, the internal structure of the device is divided into different functional units or modules, so as to complete all or part of the functions described above.

Finally, it should be noted that the presence of software tools or components other than the present company in the embodiment of the application is merely for example and does not represent actual use. The above-mentioned embodiments are merely illustrative of the technical solution of the present invention, and are not limiting thereto; although the present invention has been described in detail with reference to the foregoing embodiments, those skilled in the art will appreciate that: the technical solutions disclosed in the above-mentioned various embodiments can still be modified, or some of the technical features thereof can be replaced by equivalents; such modifications and substitutions do not depart from the spirit and scope of the embodiments of the present invention and are intended to be included within the scope of the present invention.

What is claimed is:

1. A picture detection method, comprising the steps of:
acquiring a certificate picture uploaded by a user, and confirming a portrait direction on the certificate picture so as to obtain a correct state certificate picture;
acquiring a highlight region of the correct state certificate picture;
judging whether the highlight region is a light reflection region;
if the highlight region is not a light reflection region, sending the correct state certificate picture to a server;
if the highlight region is a light reflection region, acquiring a non-light reflection region picture of the correct state certificate picture, and identifying text region defect features and portrait region defect features in the non-light reflection region picture;
using a pre-trained text region boundary identification model to identify a complete text region in the correct state certificate picture according to the text region defect features, and using a pre-trained portrait region boundary identification model to identify a complete portrait region in the correct state certificate picture according to the portrait region defect features;
dividing a key information region of the correct state certificate picture according to the complete text region and the complete portrait region so as to obtain a key information picture, and sending the key information picture to a server.

2. The picture detection method according to claim 1, wherein the step of performing portrait direction confirmation on the certificate picture to obtain a correct state certificate picture comprises:
acquiring a portrait direction of the certificate picture;
judging whether the portrait direction is a pre-set correct direction;
if the portrait direction is a pre-set correct direction, confirming that the certificate picture is a correct state certificate picture;
if the portrait direction is not a pre-set correct direction, rotating the certificate picture so that the portrait direction of the certificate picture is the correct direction, and obtaining a correct state certificate picture.

3. The picture detection method according to claim 1, wherein the step of acquiring a highlight region of the correct state certificate picture comprises:
acquiring a histogram of the correct state certificate picture;
identifying, based on the histogram, a pixel point of which a pixel value is greater than a pre-set highlight threshold value in the correct state certificate picture, and obtaining a highlight region.

4. The picture detection method according to claim 1, wherein the step of identifying the text region defect features and the portrait region defect features in the non-light reflection region picture comprises:
performing binarized processing on the non-light reflection region picture to obtain a binarized picture;
using an edge detection algorithm to identify discontinuous boundary features and defect regular edge features in the binarized picture;
using a text detection algorithm to perform text detection on the discontinuous boundary features and the defect regular edge features so as to obtain the text region defect features; and
performing portrait contour matching on the discontinuous boundary features and the defect regular edge features to obtain the portrait region defect features.

5. The picture detection method according to claim 4, wherein the step of performing binarized processing on the non-light reflection region picture to obtain a binarized picture comprises:
performing grey-scale processing on the non-light reflection region picture to obtain a grey-scale picture;
acquiring a grey-scale value of each pixel point of the grey-scale picture to obtain grey-scale value data;
acquiring a median of the grey-scale value data to obtain a grey-scale threshold value;
according to the grey-scale value data, setting the grey-scale value of a pixel point in the grey scale picture which is greater than the grey-scale threshold value as 1, and setting the grey-scale value of a pixel point which is less than or equal to the grey-scale threshold value as 0, so as to obtain a binarized image.

6. The picture detection method according to claim 1, wherein the step of using a pre-trained text region boundary identification model to identify a complete text region in the correct state certificate picture according to the text region defect features comprises:
using a neural network model to perform average pooling processing and maximum pooling processing on the text region defect features so as to obtain an average pooling feature and a maximum pooling feature;
splicing the average pooling feature and the maximum pooling feature on a channel dimension to obtain a splicing feature;
performing convolution processing and activation processing on the splicing feature to obtain a spatial attention map;
multiplying the spatial attention map and the text region defect features to obtain an attention weight; and
using a neural network model to output a complete text region of the certificate picture according to the attention weight and the text region defect features.

7. The picture detection method according to claim 6, wherein the step of the performing convolution processing and activation processing on the splicing feature to obtain a spatial attention map comprises:
using a convolution kernel with a size of 1*1 being greater than the splicing feature to perform convolution so as to obtain a convolution result with a size of 1*1*N, wherein N is the number of output channels;
expanding the convolution result in a spatial dimension to obtain a feature tensor of size N*H*W, wherein H*W is the size of the splicing feature;
mapping each element in the feature tensor between 0 and 1 using a pre-set activation function to obtain a spatial attention map.

8. An electronic equipment, comprising: a memory, a processor, the processor being electrically connected to the memory, the memory storing a computer program executable by the at least one processor, the computer program, when executed by the at least one processor, causing the at least one processor to perform the steps of:
acquiring a certificate picture uploaded by a user, and confirming a portrait direction on the certificate picture so as to obtain a correct state certificate picture;
acquiring a highlight region of the correct state certificate picture;
judging whether the highlight region is a light reflection region;
if the highlight region is not a light reflection region, sending the correct state certificate picture to a server;
if the highlight region is a light reflection region, acquiring a non-light reflection region picture of the correct state certificate picture, and identifying text region defect features and portrait region defect features in the non-light reflection region picture;
using a pre-trained text region boundary identification model to identify a complete text region in the correct state certificate picture according to the text region defect features, and using a pre-trained portrait region boundary identification model to identify a complete portrait region in the correct state certificate picture according to the portrait region defect features;
dividing a key information region of the correct state certificate picture according to the complete text region and the complete portrait region so as to obtain a key information picture, and sending the key information picture to a server.

9. The electronic equipment according to claim 8, wherein the step of performing portrait direction confirmation on the certificate picture to obtain a correct state certificate picture comprises:
acquiring a portrait direction of the certificate picture;
judging whether the portrait direction is a pre-set correct direction;
if the portrait direction is a pre-set correct direction, confirming that the certificate picture is a correct state certificate picture;
if the portrait direction is not a pre-set correct direction, rotating the certificate picture so that the portrait direction of the certificate picture is the correct direction, and obtaining a correct state certificate picture.

10. The electronic equipment according to claim 8, wherein the step of acquiring a highlight region of the correct state certificate picture comprises:
acquiring a histogram of the correct state certificate picture;
identifying, based on the histogram, a pixel point of which a pixel value is greater than a pre-set highlight threshold value in the correct state certificate picture, and obtaining a highlight region.

11. The electronic equipment according to claim 8, wherein the step of identifying the text region defect features and the portrait region defect features in the non-light reflection region picture comprises:
performing binarized processing on the non-light reflection region picture to obtain a binarized picture;
using an edge detection algorithm to identify discontinuous boundary features and defect regular edge features in the binarized picture;
using a text detection algorithm to perform text detection on the discontinuous boundary features and the defect regular edge features so as to obtain the text region defect features; and
performing portrait contour matching on the discontinuous boundary features and the defect regular edge features to obtain the portrait region defect features.

12. The electronic equipment according to claim 11, wherein the step of performing binarized processing on the non-light reflection region picture to obtain a binarized picture comprises:
performing grey-scale processing on the non-light reflection region picture to obtain a grey-scale picture;
acquiring a grey-scale value of each pixel point of the grey-scale picture to obtain grey-scale value data;
acquiring a median of the grey-scale value data to obtain a grey-scale threshold value;
according to the grey-scale value data, setting the grey-scale value of a pixel point in the grey scale picture which is greater than the grey-scale threshold value as 1, and setting the grey-scale value of a pixel point which is less than or equal to the grey-scale threshold value as 0, so as to obtain a binarized image.

13. The electronic equipment according to claim 8, wherein the step of using a pre-trained text region boundary identification model to identify a complete text region in the correct state certificate picture according to the text region defect features comprises:
using a neural network model to perform average pooling processing and maximum pooling processing on the text region defect features so as to obtain an average pooling feature and a maximum pooling feature;
splicing the average pooling feature and the maximum pooling feature on a channel dimension to obtain a splicing feature;
performing convolution processing and activation processing on the splicing feature to obtain a spatial attention map;
multiplying the spatial attention map and the text region defect features to obtain an attention weight; and
using a neural network model to output a complete text region of the certificate picture according to the attention weight and the text region defect features.

14. The electronic equipment according to claim 13, wherein the step of the performing convolution processing and activation processing on the splicing feature to obtain a spatial attention map comprises:
using a convolution kernel with a size of 1*1 being greater than the splicing feature to perform convolution so as to obtain a convolution result with a size of 1*1*N, wherein N is the number of output channels;
expanding the convolution result in a spatial dimension to obtain a feature tensor of size N*H*W, wherein H * W is the size of the splicing feature;
mapping each element in the feature tensor between 0 and 1 using a pre-set activation function to obtain a spatial attention map.

15. A non-volatile computer-readable storage medium having a computer program stored thereon, wherein the computer program, when executed by one or more processors, causes the one or more processors to perform the steps of:
acquiring a certificate picture uploaded by a user, and confirming a portrait direction on the certificate picture so as to obtain a correct state certificate picture;
acquiring a highlight region of the correct state certificate picture;
judging whether the highlight region is a light reflection region;
if the highlight region is not a light reflection region, sending the correct state certificate picture to a server;
if the highlight region is a light reflection region, acquiring a non-light reflection region picture of the correct state certificate picture, and identifying text region defect features and portrait region defect features in the non-light reflection region picture;
using a pre-trained text region boundary identification model to identify a complete text region in the correct state certificate picture according to the text region defect features, and using a pre-trained portrait region boundary identification model to identify a complete portrait region in the correct state certificate picture according to the portrait region defect features;
dividing a key information region of the correct state certificate picture according to the complete text region and the complete portrait region so as to obtain a key information picture, and sending the key information picture to a server.

16. The non-volatile computer-readable storage medium according to claim 15, wherein the step of performing portrait direction confirmation on the certificate picture to obtain a correct state certificate picture comprises:
acquiring a portrait direction of the certificate picture;
judging whether the portrait direction is a pre-set correct direction;
if the portrait direction is a pre-set correct direction, confirming that the certificate picture is a correct state certificate picture;
if the portrait direction is not a pre-set correct direction, rotating the certificate picture so that the portrait direction of the certificate picture is the correct direction, and obtaining a correct state certificate picture.

17. The non-volatile computer-readable storage medium according to claim 15, wherein the step of acquiring a highlight region of the correct state certificate picture comprises:
acquiring a histogram of the correct state certificate picture;
identifying, based on the histogram, a pixel point of which a pixel value is greater than a pre-set highlight threshold value in the correct state certificate picture, and obtaining a highlight region.

18. The non-volatile computer-readable storage medium according to claim 15, wherein the step of identifying the text region defect features and the portrait region defect features in the non-light reflection region picture comprises:
performing binarized processing on the non-light reflection region picture to obtain a binarized picture;
using an edge detection algorithm to identify discontinuous boundary features and defect regular edge features in the binarized picture;
using a text detection algorithm to perform text detection on the discontinuous boundary features and the defect regular edge features so as to obtain the text region defect features; and
performing portrait contour matching on the discontinuous boundary features and the defect regular edge features to obtain the portrait region defect features.

19. The non-volatile computer-readable storage medium according to claim 18, wherein the step of performing binarized processing on the non-light reflection region picture to obtain a binarized picture comprises:
performing grey-scale processing on the non-light reflection region picture to obtain a grey-scale picture;
acquiring a grey-scale value of each pixel point of the grey-scale picture to obtain grey-scale value data;
acquiring a median of the grey-scale value data to obtain a grey-scale threshold value;
according to the grey-scale value data, setting the grey-scale value of a pixel point in the grey scale picture which is greater than the grey-scale threshold value as 1, and setting the grey-scale value of a pixel point which is less than or equal to the grey-scale threshold value as 0, so as to obtain a binarized image.

20. The non-volatile computer-readable storage medium according to claim 15, wherein the step of using a pre-trained text region boundary identification model to identify a complete text region in the correct state certificate picture according to the text region defect features comprises:
using a neural network model to perform average pooling processing and maximum pooling processing on the text region defect features so as to obtain an average pooling feature and a maximum pooling feature;
splicing the average pooling feature and the maximum pooling feature on a channel dimension to obtain a splicing feature;
performing convolution processing and activation processing on the splicing feature to obtain a spatial attention map;
multiplying the spatial attention map and the text region defect features to obtain an attention weight; and
using a neural network model to output a complete text region of the certificate picture according to the attention weight and the text region defect features.
